(19) United States
(12) Patent Application Publication
(10) Pub. No.: US 2018/0211760 A1
(43) Pub. Date: Jul. 26, 2018

(54) ELECTROMAGNETIC COMPONENT WITH INTEGRATED MAGNETIC CORE FOR DC/DC POWER CONVERTER IN A MULTI-PHASE ELECTRICAL POWER SYSTEM

(71) Applicant: COOPER TECHNOLOGIES COMPANY, Houston, TX (US)

(72) Inventors: Zhuo Min Liu, Dublin, CA (US); Clarita Chiting Knoll, San Leandro, CA (US)

(21) Appl. No.: 15/410,855

(22) Filed: Jan. 20, 2017

(51) Int. Cl. H01F 27/24; H02M 3/04; H01F 27/28

(52) U.S. Cl. CPC H01F 27/24; H01F 27/28; H02M 3/04

(57) ABSTRACT

A magnetic core structure for an electromagnetic component includes a first magnetic core piece having a planar section and a plurality of posts extending perpendicularly to and projecting from the planar section, and a second, L-shaped magnetic core piece assembled with the first piece and in abutting contact with the plurality of posts. The component also includes a plurality of windings respectively corresponding to each phase of a DC multi-phase power system. The component may be one of a transformer or inductor component and may be included in a DC/DC power converter application having high power density and improved efficiency.

### BACKGROUND OF THE INVENTION

The field of the invention relates generally to electromagnetic components such as inductors and transformers, and more particularly to a multi-phase electromagnetic component having an integrated magnetic core structure for the coil windings in each phase of a direct-current to direct-current (DC to DC) power converter in a multi-phase electrical power system.

Electromagnetic components such as inductors and transformers are used in power supply management applications and power management circuitry for powering a host of electronic devices. Inductors are designed to induce magnetic fields via current flowing through one or more conductive windings, store energy via the generation of magnetic fields in magnetic cores associated with the windings, and return the stored energy to the associated electrical circuit by inducing current flow through the windings. Transformers utilize electromagnetic principles to induce current flow in a secondary winding from current flow in a primary winding that is otherwise electrically isolated from the secondary winding. Differences in the primary and secondary windings allow stepped-up or stepped-down voltages to be realized. Both transformers and inductors may be utilized in combination in power converter circuitry to provide regulated power from rapidly switching power supplies.

Inductor and transformer components are each known that include multiple windings integrated in a common magnetic core structure. Existing components of this type however, are problematic in some aspects and improvements are desired.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is an exemplary block diagram of a first exemplary power converter system including an electromagnetic component according to an exemplary embodiment of the present invention.

FIG. 2 is a perspective view of a first exemplary embodiment of magnetic core structure for the electromagnetic component shown in FIG. 1.

FIG. 3 is a perspective view of a second magnetic core piece for the magnetic core structure shown in FIG. 2.

FIG. 4 is a first perspective view of a first magnetic core piece for the magnetic core structure shown in FIG. 2.

FIG. 5 is a second perspective view of the first magnetic core piece shown in FIGS. 2 and 4.

FIG. 6 is a first side elevational view of the magnetic core structure shown in FIGS. 2 and 5.

FIG. 7 is a second side elevational view of the magnetic core structure shown in FIG. 2.

FIG. 8 is a perspective view of a second exemplary embodiment of magnetic core structure for the electromagnetic component shown in FIG. 1.

FIG. 9 is a first perspective view of a first magnetic core piece for the magnetic core structure shown in FIG. 8.

FIG. 10 is a second perspective view of a first magnetic core piece for the magnetic core structure shown in FIG. 8.

FIG. 11 is a perspective view of a second magnetic core piece shown in FIG. 8.

FIG. 12 is a first side elevational view of the magnetic core structure shown in FIG. 8.

FIG. 13 is a second side elevational view of the magnetic core structure shown in FIGS. 8 and 12.

FIG. 14 is an exemplary block diagram of a second exemplary power converter system including an electromagnetic component according to an exemplary embodiment of the present invention.

### DETAILED DESCRIPTION OF THE INVENTION

As mentioned above, electromagnetic components such as inductors and transformers are known that include, for example, multiple windings integrated in a single or common core structure. Such components are typically beneficial to provide multi-phase power conversion and regulation at a reduced cost relative to discrete inductor components including separate magnetic cores and windings for each respective phase of electrical power. As one example, a two phase power system can be regulated with an integrated power inductor component including two windings, and a stepped up or stepped down voltage can be realized with an integrated transformer component including two sets of windings. In either case one winding is connected to the first power phase of electrical circuitry, and the other winding is connected to the second power phase of electrical circuitry.

Apart from cost savings, providing multiple windings on a common, integrated magnetic core structure also saves valuable space in a power converter relative to providing one discrete inductor component including its own magnetic core for each phase. Such space savings can contribute to a reduction in size of the power converter, which may be implemented on a circuit board, and also any associated electronic device that may include the power converter.

Known integrated, multi-phase electromagnetic component constructions are limited, however, in certain aspects when used in certain types of power converters. As such, existing integrated, multi-phase electromagnetic components have yet to fully meet the needs of the marketplace in certain aspects.

While multi-phase electrical power systems are in widespread use including different numbers of phases of electrical power, customized electromagnetic components tend to be the norm to meet the power conversion or regulation needs of power systems having different numbers of phases. The customized nature of such components tends to increase the cost of manufacture and assembly for the components. In particular, the magnetic core constructions tend be uniquely different for inductor components having one, two, three or more windings. The different core constructions having different shapes require different types of windings or different winding techniques to complete the components, and performance variation and reliability issues accordingly may vary from component to component.

Further, the shape of magnetic core pieces in customized electromagnetic components can be rather complex, in particular as the number of phases to be connected to the component increases, adding to the cost of manufacturing the component. In many cases, an existing core structure cannot be easily modified or expanded to accommodate a multi-phase power system having greater or fewer numbers of phases. It would be desirable to provide an integrated electromagnetic component construction that can be manufactured at relatively low cost with simpler-shaped core pieces that can be more efficiently scaled to accommodate different numbers of windings without having to redesign the component.

Additionally, with the increasing demand for smaller and more efficient yet still low cost efficient DC/DC converters, performance challenges present still other issues to component manufacturers. Integrated magnetic cores advantageously reduce the amount of magnetic core material, as well as efficiency improvements with less weight and smaller volume compared to conventional use of discrete, non-integrated components connecting to each respective phase in the power system, all of which tend to increase power density and power efficiency in a power converter application. However, present day power density and efficiency requirements of power converters now demanded in the marketplace are difficult to meet with existing component designs, if they can be met at all.

Improving the integrated electromagnetic component design is believed to be one of the biggest challenges in achieving the higher power density and higher efficiency due to the significant portion of magnetics components volume in a power converter system. In particular, improvement in the magnetic core structure of integrated electromagnetic components is needed to implement a low voltage high current DC/DC converter capable of performing in a higher power density application and with the desired efficiency. Balancing such needs with the issues above concerning component complexity and cost, solutions have so far been elusive.

Exemplary embodiments of integrated electromagnetic core structures, electromagnetic components including such structures, and power converters including such electromagnetic components are described herein that provides a simple and compact integrated magnetic core structure solution for DC/DC converter systems operating at desired power density and with desired efficiency. The integrated electromagnetic core structures may be manufactured at comparatively low cost using relatively small and simple shapes of magnetic core pieces relative to conventional integrated magnetic core structures, while producing highly reliable components with uniform performance characteristics. The core pieces are readily scalable to accommodate multi-phase power systems having different numbers of phases. The core pieces facilitate winding formation in a consistent and reliable manner in a winding space that facilitates windings with even spacing and uniform flux density, thereby providing more efficient utilization of the magnetic core in use. Method steps will in part be explicitly described and in part apparent from the description below.

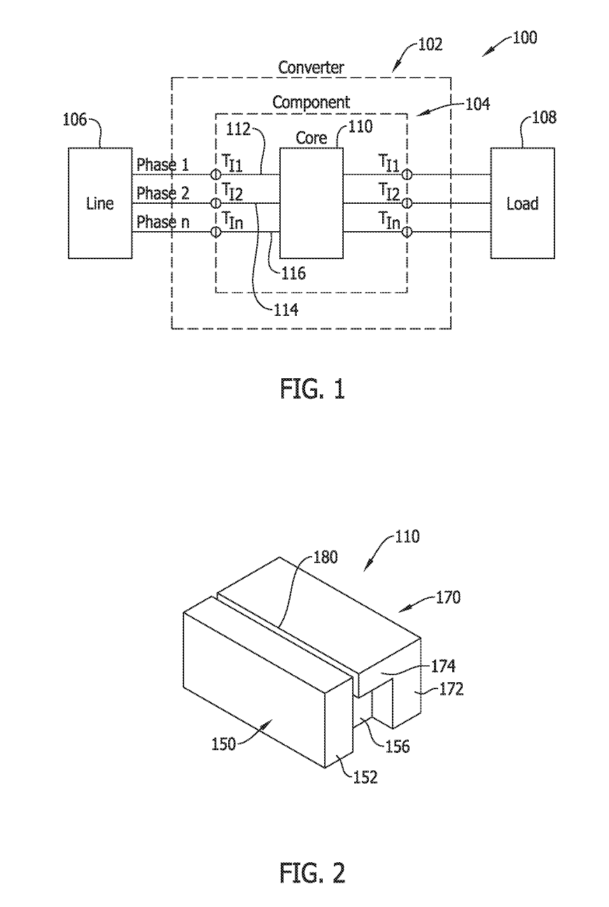

As shown in the exemplary block diagram FIG. 1, a first exemplary power converter system 100 includes a power converter 102 having at least one electromagnetic component 104 according to an exemplary embodiment of the present invention.

The power converter 102 is a generally known DC/DC power converter and interconnects a multi-phase power supply indicated in FIG. 1 as a line or power side circuit 106 and a load-side circuit 108 through the component 104. The line side power 106 is connected to the converter 102 and specifically to the component 104 via terminals T₁₁, T₁₂ . . . T₁ₙ where n is an integer number that is at least two or greater. A variety of power converter topologies are known and familiar to those in the art (e.g., buck, boost, buck-boost, etc.), any of which may be utilized and accordingly are not described in further detail herein. As one example only, the component design described further below may have particular benefits in a power converter having a Multiphase Multi-Interleave Buck topology. The power converter 102 includes switching regulators, switching controllers, and other elements to achieve multi-phase functionality. The power converter 102 is also designed as a high current input or high current output device to increase the power density and efficiency.

The component 104 includes an integrated magnetic core 110 and a number of inductor windings I₁, I₂ . . . Iₙ shown in FIG. 1 as 112, 114, 116. Each winding 112, 114, 116 is fabricated from a conductive material defining a current path in the electromagnetic structure 110, and the current path completes a number of turns in the magnetic core 110 to provide a desired inductance value, and each inductor winding 112, 114, 116 provides an output to the load-side circuit 108 via corresponding terminals T₁₁, T₁₂ . . . T₁ₙ as shown. In this example, the component 104 is a power inductor and facilitates power regulation in the converter 100. Alternatively, or in further embodiments, the component 104 may provide signal conditioning to the output power provided to the load 108. In some embodiments, both a power inductor and a conditioning inductor may be utilized in combination in the converter 102, and in any case may still include the magnetic core structure 110 described below.

Various embodiments of otherwise similar components 104 are contemplated having different numbers n of windings depending on the number of phases of power provided in the line supply 108. The number n is selected to match the number of phases in the power supply. In a two phase power system n is equal to 2 and the component 104 is configured as a dual inductor having two inductor windings I₁ and I₂ and respective connecting terminals. In a three phase power system n is equal to 3 and the component 104 includes three inductor windings I₁, I₂ and I₃ and respective connecting terminals. In a four phase power system n is equal to 4 and the component 104 includes four inductor windings I₁, I₂, I₃ and I₄ and respective connecting terminals. That is, and as explained below, the component may alternatively be configured for two, three, four or even more windings for power systems including three or more phases.

The input and output terminals T₁₁, T₁₂ . . . T₁ₙ in contemplated embodiments may be implemented for example, with surface mount terminations or through-hole terminations on a circuit board provided in the power converter 102, although other arrangements are possible. In the case of circuit board, circuit traces formed on the surface of the circuit board may provide interconnection between the component 104, other elements in the power converter 102 and/or connection to the line and load circuitry 106, 108.

As another example shown in FIG. 14, the power converter 102 includes an electromagnetic component 120 having the magnetic core 110 and a set of n primary windings 122, 124, 126 connecting to the line supply 106 at respective terminals T_{P1}, T_{P2} . . . T_{Pn}. A set of n secondary windings 128, 130, 132 are also provided in the component 120 and connect to the load circuitry 108 at respective terminals T_{S1}, T_{S2} . . . T_{Sn}. Each of the primary windings 122, 124, 126 connects to one of the n phases of the line supply 106 and induces electrical current in a respective one of the secondary windings 128, 130, 132. The primary windings 122, 124, 126 and the secondary windings 128, 130, 132 have respectively different numbers of turns to provide a stepped up or stepped down signal output to the load side circuit 108. By virtue of the primary and secondary windings the component 120 is configured as a transformer component instead of an inductor component as described above in the example of FIG. 1.

While the example of FIG. 1 includes an inductor component 104 and the example of FIG. 14 includes a transformer component 120, it is recognized that power converter 102 may include both inductor and transformer components according to the present invention as desired. As described below, the same magnetic core structure 110 is proposed to fabricate inductor and transformer components at relatively low cost with improved power density and efficiency in a power converter application.

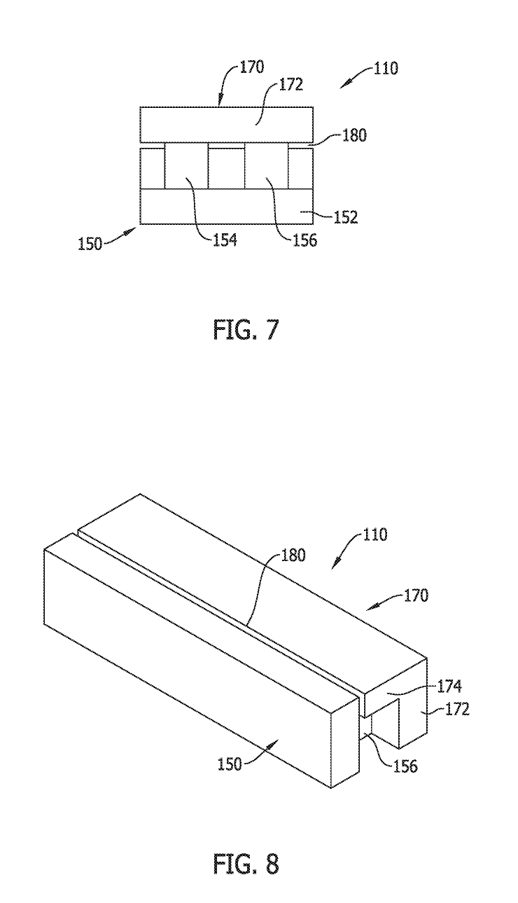

FIGS. 2 through 7 illustrate a first exemplary embodiment of the magnetic core structure 110 for the electromagnetic inductor component 104 (FIG. 1) or the electromagnetic transformer component 120 (FIG. 14).

In the example shown in FIG. 2, the magnetic core structure 110 includes a first magnetic core piece 150, sometimes referred to as a base core piece, and a second magnetic core piece 170 that are assembled to one another to complete the core structure 110.

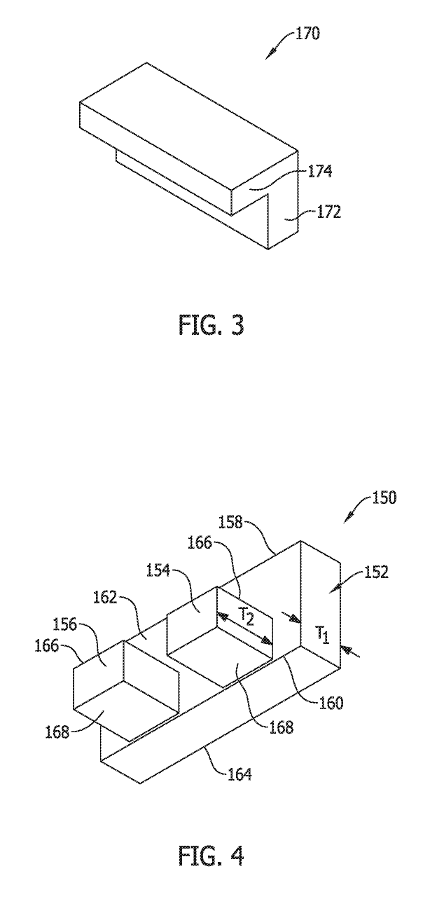

The second magnetic core piece 170 as shown in FIG. 3 is a generally L-shaped piece including pair of generally planar, plate-like sections, namely a first leg section 172 and a second leg section 174. Each of the leg sections 172, 174 are generally planar, plate-like sections that intersect and join one another at their ends in a perpendicular orientation, producing the L-shaped side profile seen in FIGS. 2 and 3. In one embodiment, the leg section 172 is longer than the leg section 174. The core piece 170 is generally rectangular in each section 172, 174 and is generally solid without openings or recesses formed therein. The core piece 170 is relatively simple in shape and contour and can easily be made using known techniques such as molding and the like using known magnetic materials.

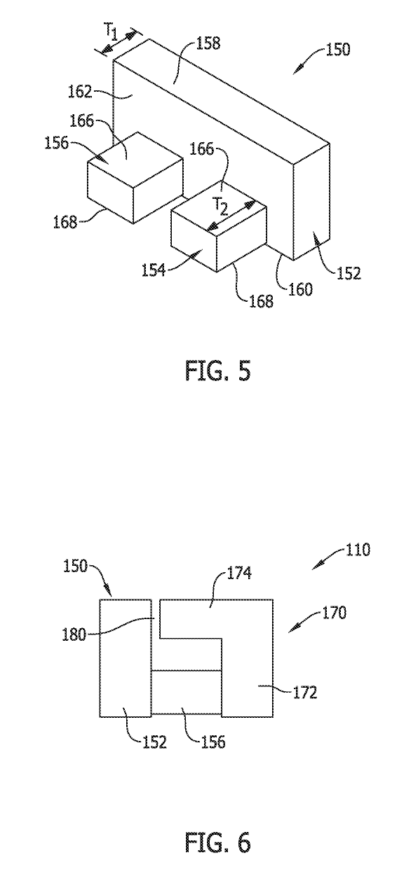

The base core piece 150 as shown in FIGS. 4 and 5 includes a single, uniformly shaped plate-like planar section 152, and a plurality of winding posts 154 and 156 extending outwardly from the planar section 152. In the example shown, the plurality of winding posts 154 and 156 extend perpendicularly to and project from one side of the planar section 152 in a spaced apart, but generally parallel manner to one another. Two winding posts 154, 156 in the example of FIGS. 4 and 5 allows the core structure 110 to accommodate a two phase power converter connected to a two phase power supply.

The planar section 152 of the first magnetic core piece includes opposing first and second side edges 158, 160, and the plurality of winding posts 154, 156 are aligned with one another proximate to and generally alongside the second edge 160. As such, the plurality of posts 154, 156 are spaced from the first side edge 158 and the second side edge 158 by an unequal amount. As seen in FIGS. 4 and 5, the plurality of winding posts 154, 156 are very slightly spaced from the edge 160 while greatly spaced from the side edge 158. Other geometric arrangements are, of course possible.

In another aspect, the planar section 152 of the base core piece 150 includes a first major side 162 and a second major side 164 opposing the first major side 162. The plurality of winding posts 154, 156 each extend from the first major side 162, while the second major side 162 is flat and does not include any posts or projections. The winding posts 154, 156 each include a first major side 166 and a second major side 168 opposing the first major side 166, and wherein the first and second major sides 166, 168 of the respective plurality of winding posts 154, 156 extends perpendicularly to the first and second major sides 162, 164 of the planar section 152 in the base core piece 150. Other geometric arrangements are, of course possible.

Additionally, and in the example illustrated, the planar section 152 of the base core piece 150 has a first thickness T₁ measured between the major sides 162 and 164. In the same dimension (i.e., measured in a direction perpendicular to the major sides 162 and 164), each of the winding posts 154, 156 have a second thickness T₂ greater than the first thickness T₁. Other geometric arrangements are, of course possible.

As illustrated, the winding posts 154, 156 are generally rectangular in shape and profile and are relatively easy to form. In another embodiment, the winding posts 154, 156 could be rounded or circular if desired instead of rectangular. The base core piece 150 including the winding posts 154, 156 is generally solid without openings or recesses formed in or through the surfaces thereof. The core piece 150, like the core piece 170 is relatively simple in shape and contour and can easily be made using known techniques such as molding and the like using known magnetic materials.

The core piece 150 including the winding posts 154, 156 define an open and accessible winding space as shown in FIGS. 4 and 5. Inductor windings or transformer windings may be assembled to the respective winding posts 154, 156 using known techniques. In the case of a transformer, the windings 154, 156 can be primary and/or secondary windings on each post, or the windings on each post can be inductor windings as described above. In contemplated embodiments, the windings can be single turn windings or multiple turn windings to provide the desired amount of inductance. A single winding may be assembled to each post 154 and 156, or multiple windings may be assembled to each post 154, 156. The windings are appreciated designed for high current DC input or high current DC output in use.

When the core pieces 150, 170 are assembled as shown in FIGS. 2, 6 and 7, the distal ends of the winding posts 154, 156 in the base core piece 150 are placed in abutting contact with the longer leg 172 of the second, L-shaped core piece 170. That is, when such abutting contact is established, there is no gap between the facing surfaces of the winding posts 154, 156 and the leg 172. The windings assembled to the posts 154, 156 are protected on one side by the planar section 152 of the base core piece 150 and on the other side by the longer leg 172 of the second, L-shaped core piece 170.

The shorter leg 174 of the second, L-shaped core piece 170 extends over the winding posts 154, 156 but in spaced apart relation from the winding posts 154, 156 as best seen in FIG. 6. Additionally, the distal end of the shorter leg 174 of the second, L-shaped core piece 170 does not reach the planar section 152 of the base core piece 150, and as a result a physical gap 180 is created or established between the planar section 152 of the base core piece 150 and the distal end of the of shorter leg 174 of the second, L-shaped core piece 170 as shown in FIGS. 2, 6 and 7. In such an arrangement the core pieces 150, 170 are sometimes referred to as being physically gapped. The physical gap 180 may beneficially provide enhanced magnetic performance when present, and in contemplated embodiments the gap 180 may be an air gap or the gap may be filled with another non-magnetic material to provide a non-magnetic gap as desired.

Also, the size of the physical gap 180 may be varied by adjusting the length of the shorter leg 174 of the core piece 150 to create wider or shallower gaps. In some cases wherein the gap 180 may not be desired, the gap 180 may be omitted and the distal end of the shorter leg 174 of the second, L-shaped core piece can be placed in abutting contact with the planar section 152 of the base core piece 150.

In contemplated embodiments, the core pieces 150, 170 may be fabricated utilizing soft magnetic particle materials and known techniques such as molding of granular magnetic particles to produce the desired shapes. Soft magnetic powder particles used to fabricate the core pieces may include Ferrite particles, Iron (Fe) particles, Sendust (Fe—Si—Al) particles, MPP (Ni—Mo—Fe) particles, HighFlux (Ni—Fe) particles, Megaflux (Fe—Si Alloy) particles, iron-based amorphous powder particles, cobalt-based amorphous powder particles, and other suitable materials known in the art. In some cases, magnetic powder particles may be are coated with an insulating material such that the core pieces 150, 170 may possess so-called distributed gap properties familiar to those in the art and fabricated in a known manner. The core pieces may be fabricated from the same or different magnetic materials and as such may have the same or different magnetic properties as desired. The magnetic powder particles used to fabricate the core pieces may be obtained using known methods and techniques and molded into the desired shapes also using known techniques.

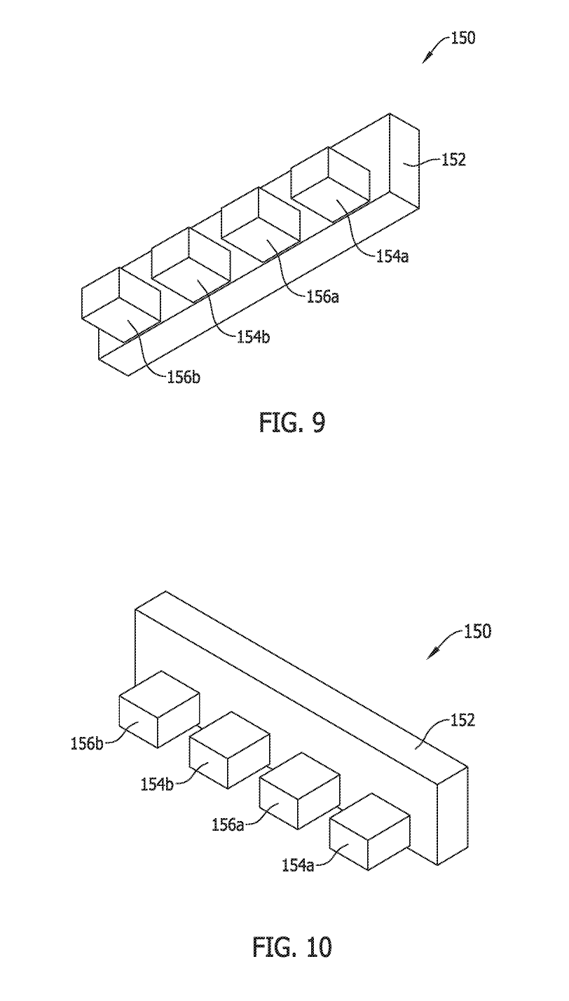

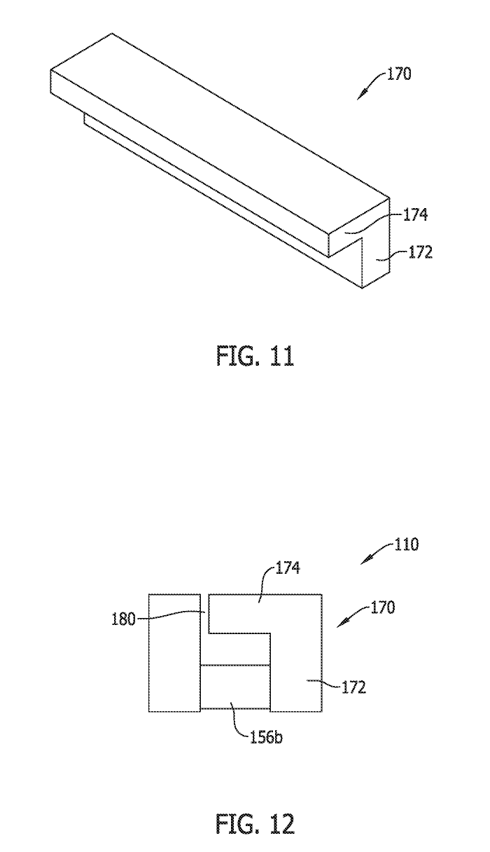

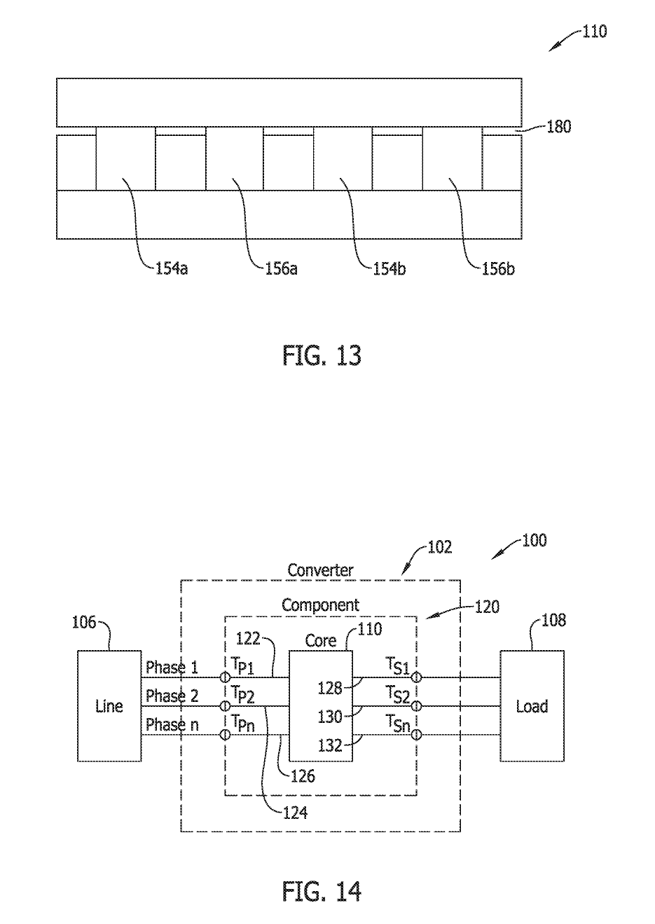

FIGS. 8-13 illustrate another embodiment of the magnetic core structure 110 that includes pieces that are similar to the pieces 150, 170 described above, but are adapted to provide additional winding posts. Comparing FIGS. 8-13 to FIGS. 2-7 is it is seen that the core piece 170 is elongated in FIGS. 8-13 relative to the embodiment illustrated in FIGS. 2-7, and the piece 150 includes two sets of posts 154a, 156a, 156a, 156b rather than the single set of posts 154, 156 illustrated in FIGS. 2-7. As such, the core structure 110 in FIGS. 8-13 includes four winding posts instead of two, and is therefore well suited for a four phase power converter application with similar benefits to those described above.

It should now be realized that the magnetic core structure 110 is generally scalable to include any desired number n of winding posts to accommodate a power system having n phases of power. In addition to the two and four phase examples depicted in the drawings having two and four winding posts respectively, the integrated magnetic core structure 100 can easily be adapted to a three phase, a five phase, and/or any other multiple phase application by including a number of winding posts to match the number of phases in the power system, and assembling windings to the posts to be connected to each phase. Regardless of the number of winding posts include, the same winding techniques and assembly may be utilized.

The benefits and advantages of the invention are now believed to have been amply illustrated in relation to the exemplary embodiments disclosed.

An embodiment of a magnetic core structure has been disclosed including: a first magnetic core piece comprising a single planar section and a plurality of winding posts extending perpendicularly to and projecting from the single planar section; and a second, L-shaped magnetic core piece assembled with the first piece and in abutting contact with the plurality of winding posts.

Optionally, an end of the second, L-shaped magnetic core piece may be physically gapped from the single planar section of the first magnetic core piece. The single planar section of the first magnetic core piece may include a first side edge and a second side edge opposing the first side edge, with the plurality of winding posts aligned with one another all of the plurality of posts being spaced from each of the first side edge and the second side edge by an unequal amount. The plurality of winding posts may also extend alongside the first side edge and be spaced from the second side edge.

As further options, the single planar section of the first magnetic core piece may include a first major side and a second major side opposing the first major side, wherein the plurality of winding posts each include a first major side and a second major side opposing the first major side, and wherein the first and second major sides of the respective plurality of winding posts extend perpendicularly to the first and second major sides of the single planar section. The single planar section of the first magnetic core piece may have a first thickness, and the plurality of winding posts may have a second thickness greater than the first thickness. The plurality of winding posts may be substantially rectangular posts.

An embodiment of an integrated electromagnetic component for a multi-phase power system has also been disclosed. The component includes: a first magnetic core piece comprising a planar section and a plurality of posts extending perpendicularly to and projecting from the planar section; a second, L-shaped magnetic core piece assembled with the first piece and in abutting contact with at least one of the plurality of posts; and a plurality of windings respectively corresponding to each phase in the multi-phase power system.

Optionally, an end of the second, L-shaped magnetic core piece may be physically gapped from the planar section of the first magnetic core piece. The planar section of the first magnetic core piece may include a first side edge and a second side edge opposing the first side edge, with the plurality of posts aligned with one another all of the plurality of posts being spaced from each of the first side edge and the second side edge by an unequal amount. The plurality of posts may also extending alongside the first side edge and be spaced from the second side edge.

As further options, the planar section of the first magnetic core piece may include a first major side and a second major side opposing the first major side, wherein the plurality of posts each include a first major side and a second major side opposing the first major side, and wherein the first and second major sides of the respective plurality of posts extend perpendicularly to the first and second major sides of the planar section. The planar section of the first magnetic core piece may also have a first thickness, and wherein the plurality of posts have a second thickness greater than the first thickness. The plurality of posts may be substantially rectangular posts.

An embodiment of a DC/DC power converter has been disclosed including: at least one transformer or inductor component including: a first magnetic core piece comprising a planar section and a plurality of posts extending perpendicularly to and projecting from the planar section; a second, L-shaped magnetic core piece assembled with the first piece and in abutting contact with the plurality of posts; and a plurality of windings respectively corresponding to each phase of a DC multi-phase power system in the converter.

Optionally, an end of the second, L-shaped magnetic core piece may be physically gapped from the planar section of the first magnetic core piece. The planar section of the first magnetic core piece may include a first side edge and a second side edge opposing the first side edge, with the plurality of posts aligned with one another all of the plurality of posts being spaced from each of the first side edge and the second side edge by an unequal amount. The plurality of posts may also extend alongside the first side edge and be spaced from the second side edge.

As further options, the planar section of the first magnetic core piece may include a first major side and a second major side opposing the first major side, wherein the plurality of posts each include a first major side and a second major side opposing the first major side, and wherein the first and second major sides of the respective plurality of posts extends perpendicularly to the first and second major sides of the planar section. The planar section of the first magnetic core piece may have a first thickness, and wherein the plurality of posts may have a second thickness greater than the first thickness.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A magnetic core structure comprising:
a first magnetic core piece comprising a single planar section and a plurality of winding posts extending perpendicularly to and projecting from the single planar section; and
a second, L-shaped magnetic core piece assembled with the first piece and in abutting contact with the plurality of winding posts.

2. The magnetic core structure of claim 1, wherein an end of the second, L-shaped magnetic core piece is physically gapped from the single planar section of the first magnetic core piece.

3. The magnetic core structure of claim 1, wherein the single planar section of the first magnetic core piece includes a first side edge and a second side edge opposing the first side edge, the plurality of winding posts aligned with one another all of the plurality of posts being spaced from each of the first side edge and the second side edge by an unequal amount.

4. The magnetic core structure of claim 1, wherein the single planar section of the first magnetic core piece includes a first side edge and a second side edge opposing the first side edge, the plurality of winding posts extending alongside the first side edge and being spaced from the second side edge.

5. The magnetic core structure of claim 1, wherein the single planar section of the first magnetic core piece includes a first major side and a second major side opposing the first major side, wherein the plurality of winding posts each include a first major side and a second major side opposing the first major side, and wherein the first and second major sides of the respective plurality of winding posts extend perpendicularly to the first and second major sides of the single planar section.

6. The magnetic core structure of claim 1, wherein the single planar section of the first magnetic core piece has a first thickness, and wherein the plurality of winding posts have a second thickness greater than the first thickness.

7. The magnetic core structure of claim 1, wherein the plurality of winding posts are substantially rectangular.

8. An integrated electromagnetic component for a multi-phase power system, the component comprising:
a first magnetic core piece comprising a planar section and a plurality of posts extending perpendicularly to and projecting from the planar section;
a second, L-shaped magnetic core piece assembled with the first piece and in abutting contact with at least one of the plurality of posts; and
a plurality of windings respectively corresponding to each phase in the multi-phase power system.

9. The integrated electromagnetic component of claim 8, wherein an end of the second, L-shaped magnetic core piece is physically gapped from the planar section of the first magnetic core piece.

10. The integrated electromagnetic component of claim 8, wherein the planar section of the first magnetic core piece includes a first side edge and a second side edge opposing the first side edge, the plurality of posts aligned with one another all of the plurality of posts being spaced from each of the first side edge and the second side edge by an unequal amount.

11. The integrated electromagnetic component of claim 10, wherein the planar section of the first magnetic core piece includes a first side edge and a second side edge opposing the first side edge, the plurality of posts extending alongside the first side edge and being spaced from the second side edge.

12. The integrated electromagnetic component of claim 8, wherein the planar section of the first magnetic core piece includes a first major side and a second major side opposing the first major side, wherein the plurality of posts each include a first major side and a second major side opposing the first major side, and wherein the first and second major sides of the respective plurality of posts extend perpendicularly to the first and second major sides of the planar section.

13. The integrated electromagnetic component of claim 8, wherein the planar section of the first magnetic core piece has a first thickness, and wherein the plurality of posts have a second thickness greater than the first thickness.

14. The integrated electromagnetic component of claim 8, wherein the plurality of posts are substantially rectangular.

15. A DC/DC power converter comprising:
at least one transformer or inductor component comprising:
a first magnetic core piece comprising a planar section and a plurality of posts extending perpendicularly to and projecting from the planar section;
a second, L-shaped magnetic core piece assembled with the first piece and in abutting contact with the plurality of posts; and
a plurality of windings respectively corresponding to each phase of a DC multi-phase power system in the converter.

16. The power converter of claim 15, wherein an end of the second, L-shaped magnetic core piece is physically gapped from the planar section of the first magnetic core piece.

17. The power converter of claim 15, wherein the planar section of the first magnetic core piece includes a first side edge and a second side edge opposing the first side edge, the plurality of posts aligned with one another all of the plurality of posts being spaced from each of the first side edge and the second side edge by an unequal amount.

18. The power converter of claim 15, wherein the planar section of the first magnetic core piece includes a first side edge and a second side edge opposing the first side edge, the plurality of posts extending alongside the first side edge and being spaced from the second side edge.

19. The power converter of claim 15, wherein the planar section of the first magnetic core piece includes a first major side and a second major side opposing the first major side, wherein the plurality of posts each include a first major side and a second major side opposing the first major side, and wherein the first and second major sides of the respective plurality of posts extend perpendicularly to the first and second major sides of the planar section.

20. The power converter of claim 15, wherein the planar section of the first magnetic core piece has a first thickness, and wherein the plurality of posts have a second thickness greater than the first thickness.
